(19) United States
(12) Patent Application Publication
(10) Pub. No.: US 2008/0264275 A1
(43) Pub. Date: Oct. 30, 2008

(54) Embossing apparatus

(76) Inventors: Lee Delson Wilhelm, Appleton, WI (US); William Allen Wengeler, Neenah, WI (US); David John Verbael, Neenah, WI (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/799,382

(22) Filed: Apr. 30, 2007

(51) Int. Cl. B30B 3/04

(52) U.S. Cl. 100/210

(57) ABSTRACT

A rigid embossing roll having an embossing surface containing at least one embossing line element. An elastomeric covered roll opposing the rigid embossing roll and the at least one embossing line element comprising a top having a first edge, a second edge opposing the first edge, and a width, A, measured between the first and the second edge. A step located adjacent to either the first or the second edge, the step having a riser and a landing. The landing having a width, B, measured between the riser and a sidewall of the embossing line element and the riser having a vertical height, C, measured along an axis orthogonal to a base of the embossing line element between the landing and the top. Finally, A is between about 0.010 inch to about 0.10 inch, B is between about 0.010 inch to about 0.10 inch, C is between about 0.0025 inch to about 0.015 inch; a ratio C/B is between about 0.25 to about 1.5; and a ratio of A/B is between about 0.1 to about 10.0.

### BACKGROUND

Embossing refers to the act of mechanically working a substrate to cause the substrate to conform under pressure to the depths and contours of a pattern engraved or otherwise formed on an embossing roll. It is widely used in the production of consumer goods. Manufacturers use the embossing process to impart a texture or relief pattern into products made of textiles, paper, synthetic materials, plastic materials, metals, and wood.

Often an embossing roll includes a plurality of individual embossing elements which are configured to form an embossing design. Recently, there has been a trend away from designs formed from dot or dash elements having a relatively small embossed area towards designs formed from curvilinear line elements having a much higher embossed area. For example, flowers, butterflies, and geometric patterns are now typically made from substantially continuous curvilinear line elements as opposed to a series of discrete dot or dash elements. Patterns formed from curvilinear line elements tend to have a better aesthetic appeal than patterns formed from dot or dash elements, which can have a stippled appearance. It is believed for a given embossing nip load, the net force each embossing element imparts to the substrate being embossed can be significantly less when using a curvilinear line element (more area) as opposed to a dot element (less area). Thus, a possible result when changing to a curvilinear line element from a dot element can be a significant loss of clarity in the resulting embossing pattern in the substrate.

In the production of paper, such as tissue paper, it is often desirable to combine a high degree of softness, which contributes to a good feeling for the user, with an appealing aesthetic appearance. Embossing a tissue substrate often contributes to a voluminous and soft feel while improving the aesthetic appearance. Improving the embossing process and the visual appearance of the embossed substrate can improve the tissue's properties and/or the user's perception. Consumers of today's premium tissue products look for crisp embossing patterns in the finished product. Consumer's frequently equate a high degree of embossing clarity as a signal of quality since frequently they cannot touch or feel the tissue product prior to purchasing it. Thus, there is a general objective in the embossing field to improve the appearance and embossing definition produced in the substrate by the embossing process. Further, there is also a need to improve the embossing definition for patterns utilizing curvilinear or linear line elements.

### SUMMARY

The inventors have discovered that, in one embodiment, by including a small step or series of notches in the top surface of a line embossing element, the embossing definition in a paper substrate can be enhanced when using a steel/rubber embossing nip. By controlling the specific geometry of the step or notch, the elastomeric surface of the rubber roll can flow into the step or notch thereby creating additional pinch points along the surface of the curvilinear line element. The additional pinch points can further set and define the embossing pattern in the substrate helping to improve the embossing clarity when using a line embossing element.

Hence, in one embodiment, the invention resides in an apparatus including a rigid embossing roll having an embossing surface containing at least one embossing line element. An elastomeric covered roll opposing the rigid embossing roll and the at least one embossing line element comprising a top having a first edge, a second edge opposing the first edge, and a width, A, measured between the first and the second edge. A step located adjacent to either the first or the second edge, the step having a riser and a landing. The landing having a width, B, measured between the riser and a sidewall of the embossing line element and the riser having a vertical height, C, measured along an axis orthogonal to a base of the embossing line element between the landing and the top. Finally, A is between about 0.010 inch to about 0.10 inch, B is between about 0.010 inch to about 0.10 inch, C is between about 0.0025 inch to about 0.015 inch; a ratio C/B is between about 0.25 to about 1.5; and a ratio of A/B is between about 0.1 to about 10.0.

### BRIEF DESCRIPTION OF THE DRAWINGS

The above aspects and other features, aspects, and advantages of the present invention will become better understood with regard to the following description, appended claims, and accompanying drawings in which:

FIG. 1 is a perspective view of one embodiment of an embossing element having a small step along one edge of the element's top surface.

FIG. 2 is a perspective view of another embodiment of an embossing element having a series of notches along one edge of the element's top surface.

FIG. 3 is a perspective view of another embodiment of an embossing element having a series of notches along both edges of the element's top surface.

FIG. 4 is a perspective view of another embodiment of an embossing element having a series of notches along one edge of the element's top surface.

FIG. 5 is a perspective view of another embodiment of an embossing element having a series of apertures indented into the element's top surface.

FIG. 6 is a side view of tissue web disposed between an engraved embossing roll nipped with an elastomeric covered roll.

FIG. 7 is a perspective view of a flower embossing pattern formed from curvilinear embossing line elements having a step along one edge of the element's top surface.

FIG. 8 is a perspective view of another embossing element having a series of differently shaped notches along one edge of the element's top surface.

Repeated use of reference characters in the specification and drawings is intended to represent the same or analogous features or elements of the invention.

### DEFINITIONS

As used herein, including the claims, forms of the words “comprise,” “have,” and “include” are legally equivalent and open-ended. Therefore, additional non-recited elements, functions, steps or limitations may be present in addition to the recited elements, functions, steps, or limitations.

As used herein “substrate” is a flexible sheet or web material, which is useful for household chores, personal care, health care, food wrapping, or cosmetic application or removal. Non-limiting examples of suitable substrates include nonwoven substrates; woven substrates; hydro-entangled substrates; air-entangled substrates; paper substrates comprising cellulose such as tissue paper, toilet paper, paper towels, paper napkins, or facial tissue; waxed paper substrates; coform substrates comprising cellulose fibers and polymer fibers; wet substrates such as wet wipes, moist cleaning wipes, moist toilet paper wipes, and baby wipes; film or plastic substrates such as those used to wrap food; and metal substrates such as aluminum foil. Furthermore, laminated or plied together substrates of two or more layers of any of the preceding substrates are also suitable.

### DETAILED DESCRIPTION

It is to be understood by one of ordinary skill in the art that the present discussion is a description of specific embodiments only and is not intended to limit the broader aspects of the present invention.

An embossing pattern on a substrate can be applied using at least one engraved rigid roll in combination with an elastomeric covered roll that forms a nip through which the substrate passes. One or multiple embossing nips in series can be used to emboss the substrate's surface. The nips can be adjusted to either a specific loading force pushing the two surfaces together, or set for a specific deformation of the elastomeric covered roll such as a fixed nip width. The elastomeric roll, commonly known in the art as a rubber roll, has a surface that deforms and yields when pressed against a raised embossing pattern on the rigid roll. As the substrate passes through the nip between the rolls, the pattern on the rigid roll is imparted onto the substrate. The pattern in the rigid embossing roll can be engraved by a variety of methods known to those of skill in the art such as laser engraving, mechanical engraving using an engraving tool, or cutting a pattern in the surface with a machine tool such as a CNC machine and milling bit.

Typically, a steel roll is used as the rigid roll; however, plastic surfaces, other metal surfaces, or any other material significantly harder than the covering on the elastomeric roll can be used. The elastomeric covered roll desirably has an outer surface hardness between approximately 40 to approximately 80 Durometer on the Shore A scale or between approximately 60 Shore A to about approximately 70 Shore A. The elastomeric covered roll desirably has a steel core that is covered with an elastomeric material having a thickness between about 0.375 inch to about 1 inch (about 9.5 mm to about 24.5 mm) and desirably between about 0.5 inch to about 0.625 inch (about 12.7 mm to about 15.9 mm). Typical materials useful for covering the elastomeric roll include natural or synthetic rubber, Hypalon® from DuPont, Nitrile rubber, Poly-Urethane, Hydrogenated Nitrile, Styrene rubber and EPDM rubber.

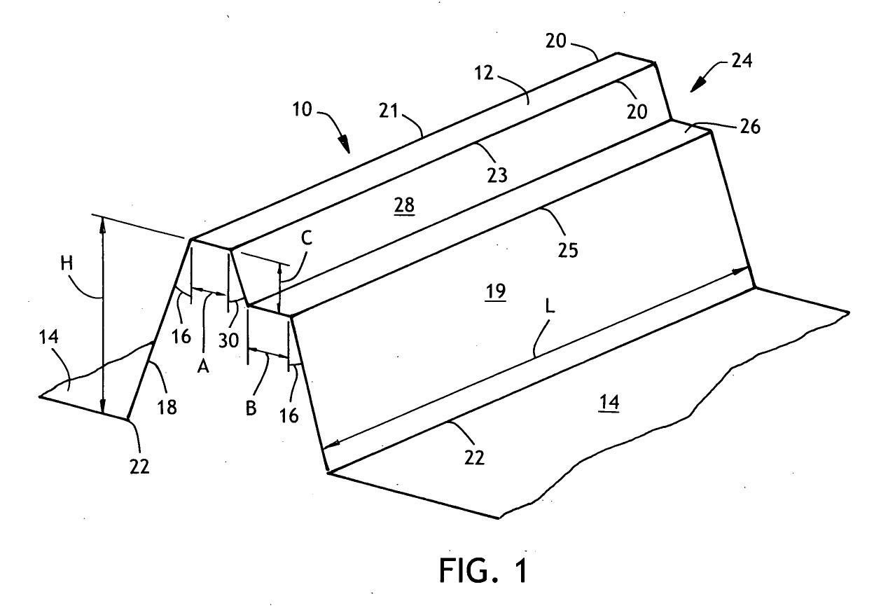

Referring to FIG. 1, an embossing line element 10 is illustrated. The embossing line element 10 can be linear, curvilinear, or a combination of linear and curvilinear segments. The embossing line element 10 has an engraved height, H, that refers to the vertical distance along an orthogonal axis to a base 14. The height is measured between the base 14 and a top 12 and of the embossing line element 10. The chosen element height is often different depending on the embossing pattern and application. Higher element heights are generally used in situations that require a large increase in bulk of the substrate being embossed. Lower element heights are generally used in situations that require a denser finished product.

Typical element heights for embossing paper towel substrates are generally between about 0.040 inch to about 0.075 inch (about 1.0 mm to about 1.9 mm), with about 0.055 inch (about 1.4 mm) being fairly common. Typical element heights for bath tissue substrates are generally between about 0.020 inch to about 0.055 inch (about 0.5 mm to about 1.4 mm), with about 0.040 inch (about 1.0 mm) often selected as a starting point. Typical element heights for paper napkin substrates are generally between about 0.025 inch to about 0.045 inch (about 0.6 mm to about 1.1 mm), with about 0.035 inch (about 0.9 mm) being fairly common. Two patents referencing embossing element heights are U.S. Pat. No. 5,693,403 issued to Brown et al. on Dec. 2, 1997 entitled Embossing With Reduced Element Height and U.S. Pat. No. 6,077,390 issued to Salman et al. on Jun. 20, 2000 entitled Calendered and Embossed Tissue Products.

Sidewall angle 16 refers to the angle of a first sidewall 18 and a second sidewall 19 extending from the base 14 of the embossing line element 10 with respect to an orthogonal axis that intersects with the base. Sidewall angles are generally +3 to +30 degrees, with +22 degrees being common. In general, larger sidewall angles are easier to engrave and keep clean of dust in operation, while smaller sidewall angles can provide improved embossing clarity or ply attachment.

A top radius 20 and a bottom radius 22 refer to the radius of curvature at the top and bottom of the embossing line element. Bottom radius 22 is the radius along the edges where the first and second sidewalls (18, 19) meet the base 14. Top radius 20 is the radius along the edges of the top 12, such as the first edge 21 where the fist sidewall 18 meets the top 12 or the second edge 23 opposed to the first edge. The top and bottom radii (20, 22) are generally the same, and range from about 0.001 inch to about 0.010 inch (about 0.03 mm to about 0.25 mm), with about 0.005 inch (about 0.13 mm) being fairly common. In general, larger radii are easier to engrave and result in less degradation at a given embossing level, while smaller top radii are better for embossing clarity and result in more bulk at a given embossing level.

Embossing line element 10 also includes a step 24 adjacent to the top surface 12 of the element. The step 24 can be located adjacent either edge (21, 23) of the top 12. The step 24 includes a landing 26 that is substantially parallel with the base 14 and a riser 28. The riser 28 is angled relative to an orthogonal axis to the base 14, and the riser angle 30 from an orthogonal axis to the base is generally in the same range as the sidewall angle 16 for the sidewalls (18, 19). In various embodiments of the invention, the riser angle 30 can be between about +3 to about +30 degrees from an orthogonal axis to the base.

The embossing line element's top 12 has a width designated as A measured between the first and second edges (21, 23), and the landing 26 has a width measured between the riser 28 and the second sidewall 19 designated as B. The riser 28 has a height measured vertically between the top 12 and the landing 26 along an orthogonal axis to the base 14 designated as C. Furthermore, the line embossing element 10 has a length, L, measured along the element where the sidewall 18 joins the base 14. The length of the embossing line element 10 is the total length measured along the curvature, if any, of the element. The step 24 has substantially the same length L as and the embossing line element 10. In general, the length, L, is greater than or equal to about 0.100″ (about 2.5 mm), or greater than or equal 3A. As such, the embossing line element 10 is significantly longer than a typical “dot” embossing element having a substantially circular top 12.

The inventors have determined that improved embossing clarity in tissue paper results if the geometry of the step 24 is within specified dimensions, and if certain ratios of the dimensions are within specified ranges. By keeping the parameters within the bounds described in Table 1, the elastomeric surface of the rubber roll is able to flow into the cavity defined by the step 24 thereby creating additional pinch points were the landing 26 meets the second sidewall 19 forming a third edge 25 and where the riser 28 meets the top 12 along the second edge 23. These additional pinch points create more permanent folds and creases in the tissue improving the embossing clarity in the embossed product when using a steel/rubber embossing nip. Referring to Table 1, the ranges for the parameters in inches and millimeters are provided.

TABLE 1
STEP GEOMETRY

| | | Low | | High | |
|---|---|---|---|---|---|
| Parameter | Minimum | Preferred | Desirable | Preferred | Maximum |
| A | 0.010″ | 0.013″ | 0.015″ | 0.045″ | 0.100″ |
| | (0.25 mm) | (0.33 mm) | (0.38 mm) | (1.14 mm) | (2.54 mm) |
| B | 0.010″ | 0.013″ | 0.015″ | 0.045″ | 0.100″ |
| | (0.25 mm) | (0.33 mm) | (0.38 mm) | (1.14 mm) | (2.54 mm) |
| C | 0.0025″ | 0.004″ | 0.005″ | 0.010″ | 0.015″ |
| | (0.06 mm) | (0.10 mm) | (0.13 mm) | (0.25 mm) | (0.34 mm) |
| Ratio C/B | 0.25 | 0.38 | 0.50 | 1.0 | 1.5 |
| Ratio A/B | 0.1 | 0.6 | 1.0 | 3.0 | 10.0 |
| Ratio | 3.0 | >5.5 | >8.0 | 400 | No |
| L/(A + B) | | | | | maximum |

The values of the various parameters in Table 1 are approximate and should be read or construed as if the term approximately or about was placed in front of the number. The individual values listed under the column headings for a single row can be used to form ranges for the particular parameter. A parameter range can be established by taking the minimum value and the maximum value listed for a parameter. For example, parameter A can be between about 0.010 inch to about 0.1 inch (about 0.25 mm to about 2.54 mm).

Additional ranges within the maximum and minimum for any row can be formed by using any pair of column headings to create two endpoints of the range within the row. For example, possible ranges for any parameter listed are: between the minimum to the maximum, between the minimum to the high preferred, between the minimum to the desirable, between the minimum to the low preferred, between the low preferred to the maximum, between the low preferred to the high preferred, between the low preferred to the desirable, between the desirable to the maximum, between the desirable to the high preferred, or between the high preferred to the maximum.

In general, as the step 24 becomes too large by increasing B or C relative to A, the embossing clarity drops off. It is believed that the decreased embossing clarity results from the rubber roll pinching the tissue more by the shelf 24 than by the top 12. Ideally, the pinch forces created in the embossed substrate by the top 12 and the shelf 24 should be comparable such that similar pressures or forces occur at the top edges (21, 23) and at the third edge 25. Thus, by maintaining the geometry with the ranges specified in Table 1, significantly improved embossing clarity results when using a steel/rubber embossing nip. In general, as the parameters approach the column labeled Desirable improved embossing clarity results in tissue paper products.

In a preferred embodiment for bath tissue and paper napkins, the parameters in Table 1 can be further reduced in range. For bath tissue and napkins, the tissue paper tends to be lower in basis weight and thinner. Also, embossing for bath tissue and paper napkins is more for decorative affect and less for building bulk/volume into the finished product. Thus, for bath tissue and napkins, A can be between about 0.010 inch to about 0.020 inch (about 0.25 mm to about 0.51 mm), B can be between about 0.010 inch to about 0.020 inch (about 0.25 mm to about 0.51 mm), C can be between about 0.004 inch to about 0.010 inch (0.10 mm to about 0.25 mm), the ratio C/B can be between about 0.38 to about 1.0, and the ratio A/B can be between about 0.6 to about 3.0. It is not necessary that all of the parameters are each within the desired ranges. For example, A could be 0.018 inch (about 0.46 mm) and C could be 0.018 inch (about 0.46 mm).

In a preferred embodiment for paper towels, the parameters in Table 1 can be further reduced in range. For paper towels, the tissue paper tends to be higher in basis weight and thicker. Also, embossing for paper towels is more often performed to generate bulk/volume with less emphasis on decoration. Thus, for paper towels, A can be between about 0.020 inch to about 0.040 inch (about 0.51 mm to about 1.02 mm), B can be between about 0.020 inch to about 0.040 inch (about 0.51 mm to about 1.02 mm), C can be between about 0.004 inch to about 0.010 inch (about 0.10 mm to about 0.25 mm), the ratio C/B can be between about 0.38 to about 1.0, and the ratio A/B can be between about 0.6 to about 3.0. It is not necessary that all of the parameters are within each of the identified ranges. For example A could be 0.018 inch (0.46 mm) and C could be 0.018 inch (0.46 mm).

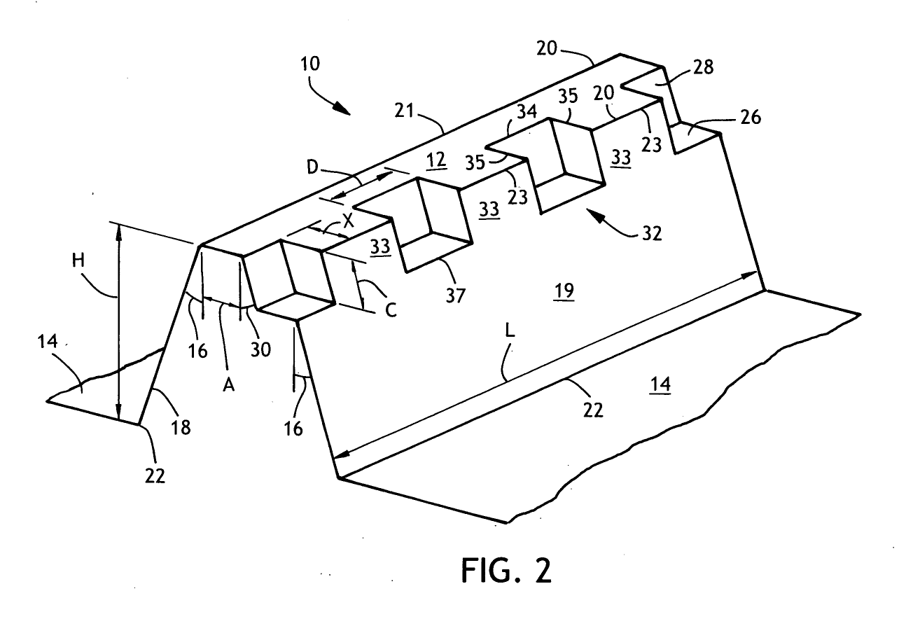

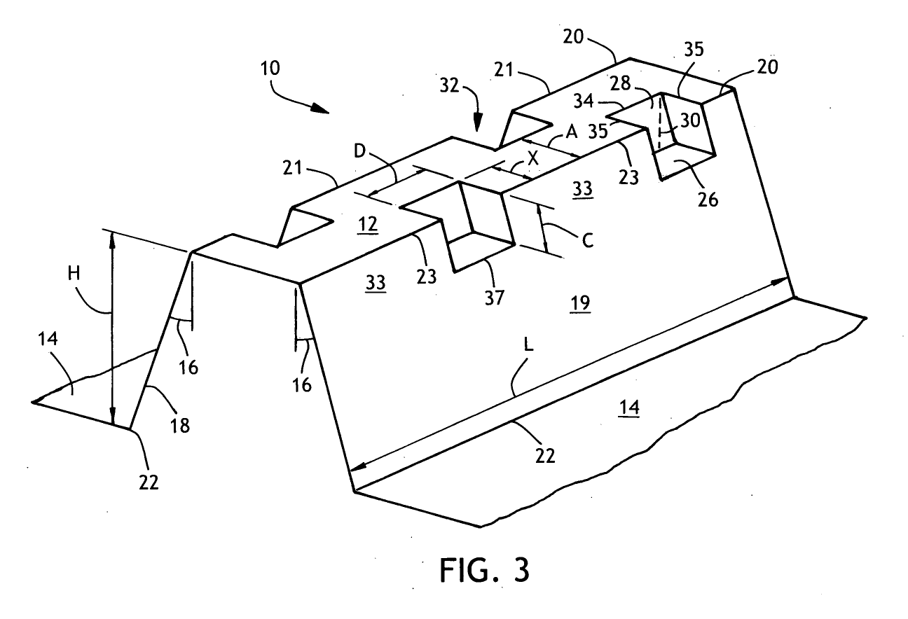

Referring now to FIGS. 2 and 3 two additional embodiments of the embossing line element 10 is shown. The embossing line element 10 can be linear, curvilinear, or a combination of linear and curvilinear segments. The embossing line element 10 has an engraved height, H, that refers to the vertical distance along an orthogonal axis to a base 14. The height is measured between the base 14 and a top 12 and of the embossing line element 10. The chosen element height is often different depending on the embossing pattern and application. Higher element heights are generally used in situations that require a large increase in bulk of the substrate being embossed. Lower element heights are generally used in situations that require a denser finished product. Typical element heights for embossing paper towel substrates are generally between about 0.040 inch to about 0.075 inch (about 1.0 mm to about 1.9 mm), with about 0.055 inch (about 1.4 mm) being fairly common. Typical element heights for bath tissue substrates are generally between about 0.020 inch to about 0.055 inch (about 0.5 mm to about 1.4 mm), with about 0.040 inch (about 1.0 mm) often selected as a starting point. Typical element heights for paper napkin substrates are generally between about 0.025 inch to about 0.045 inch (about 0.6 mm to about 1.1 mm), with about 0.035 inch (about 0.9 mm) being fairly common.

Sidewall angle 16 refers to the angle of a first sidewall 18 and a second sidewall 19 extending from the base 14 of the embossing line element 10 with respect to an orthogonal axis that intersects with the base. Sidewall angles are generally +3 to +30 degrees, with +22 degrees being common. In general, larger sidewall angles are easier to engrave and keep clean of dust in operation, while smaller sidewall angles can provide improved embossing clarity or ply attachment.

A top radius 20 and a bottom radius 22 refer to the radius of curvature at the top and bottom of the embossing element. Bottom radius 22 is the radius where the first and second sidewalls (18, 19) meet the base 14. Top radius 20 is the radius along either a first edge 21 or second edge 23 of the top 12, where the first and second sidewalls (18, 19) meet the top 12. The top and bottom radii (20, 22) are generally the same, and range from about 0.001 inch to about 0.010 inch (about 0.03 mm to about 0.25 mm), with about 0.005 inch (about 0.13 mm) being fairly common. In general, larger radii are easier to engrave and result in less degradation at a given embossing level, while smaller top radii are better for embossing clarity and result in more bulk at a given embossing level.

Embossing line element 10 also includes a plurality of notches 32 that are formed by a plurality of integral blocks 33 spaced along the step 24 of FIG. 1. In the case of FIG. 2, the embossing line element 10 can be thought of as having the step 24 of FIG. 1 with three integral blocks 33 equally spaced along the step. In the case of FIG. 3, conceptually the embossing line element 10 can be thought of as having a step 24 (FIG. 1) along both sides of the element with a plurality of staggered blocks 33 placed along both steps thereby forming a plurality of staggered notches 32 along both the first and second edges (21, 23). The plurality of notches 32 removes metal from the top 12 of the element along either the first or second edge (21, 23), but does not cut completely through the top from the first edge 21 to the second edge 23. The plurality of notches 32 can remove metal along either the first or the second edge of the top 12 (21 or 23 FIG. 2) or along both edges (FIG. 3).

Without wishing to be bound by theory, it is believed that the plurality of notches 32 increases the total circumferential distance along the perimeter of the top 12, which then increases the clarity of the embossing pattern. For example, assuming the embossing line element 10 in FIG. 2 did not have any notches 32, the total distance along the perimeter of the top 12 would equal approximately 2L+2(A+X). In FIG. 2, the total distance along the perimeter of the top 12 is increased by approximately (2X * the number of notches) over total distance along the perimeter of the top 12 without any notches; especially, as the element length is significantly increased or the number of notches is significantly increased. In the drawing X represents the width of the notch 32 cut into the top 12. Each notch 32, when formed as a square recess, has a recessed top edge 34 and two inside top edges 35 present in the surface of the top 12. The recessed top edge 34 does not contribute significantly to an increase in the total distance of the top's perimeter since it is merely relocated from the second edge 23 to an inboard position on the embossing line element 10. However, as the depth of the notches becomes more appreciable, the two inside top edges 35 do add significant distance (approximately 2X * the number of notches) to the top's perimeter. The additional inside top edges 35 provide more folding and pattern setting edges in the embossing line element 10 having essentially the same overall length, L, as an embossing element without any notches. Since the tissue is creased along more edges and along more total perimeter length, improved embossing clarity occurs.

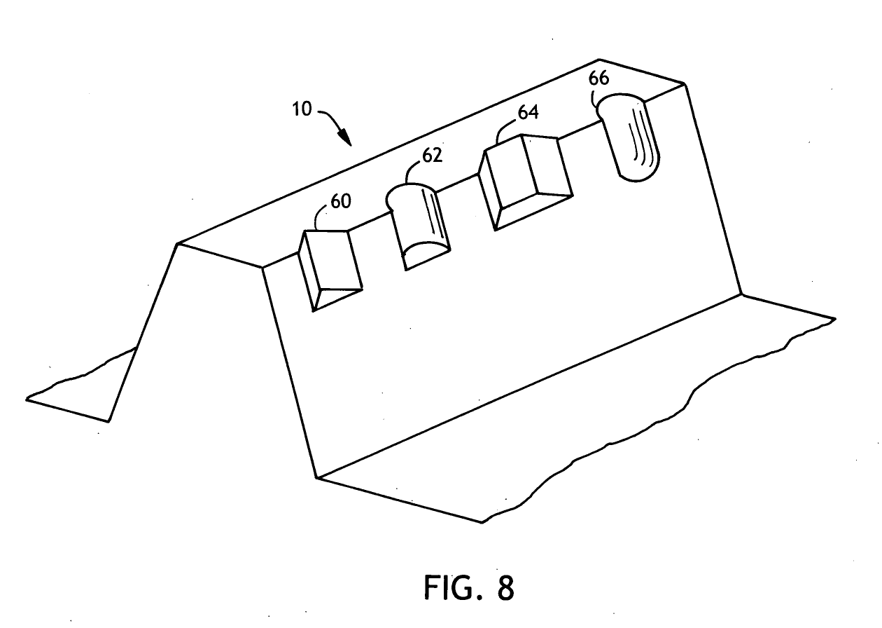

The plurality of notches 32 can have alternative shapes besides the substantially square shape illustrated. For example, the plurality of notches 32, when viewed in the top surface, can be square, rectangular, triangular, trapezoidal, wedge shaped, sinusoidal, oval, circular, U-shaped, or other shape that adds more folding edge length to the top's perimeter. Referring to FIG. 8, a triangular notch 60, a cylindrical notch 62 having a flat bottom, a trapezoidal notch 64, and an oval notch 66 having a hemispherical bottom and cylindrical sides are desirable notch profiles. Frequently, the sidewalls and bottom of a square notch 32 can become rounded when using a laser engraving process to make the notches, resulting in an oval notch 66 as illustrated.

The plurality of notches 32 can all be located along the same edge of the top 12, such as along the second edge 23 as shown in FIG. 2. Alternatively, the plurality of notches 32 can all be located along the first edge 21 of the embossing line element 10. Alternatively, the plurality of notches 32 can be staggered and offset by being placed along both the first and second edges (21, 23) of the top 12 as shown in FIG. 3.

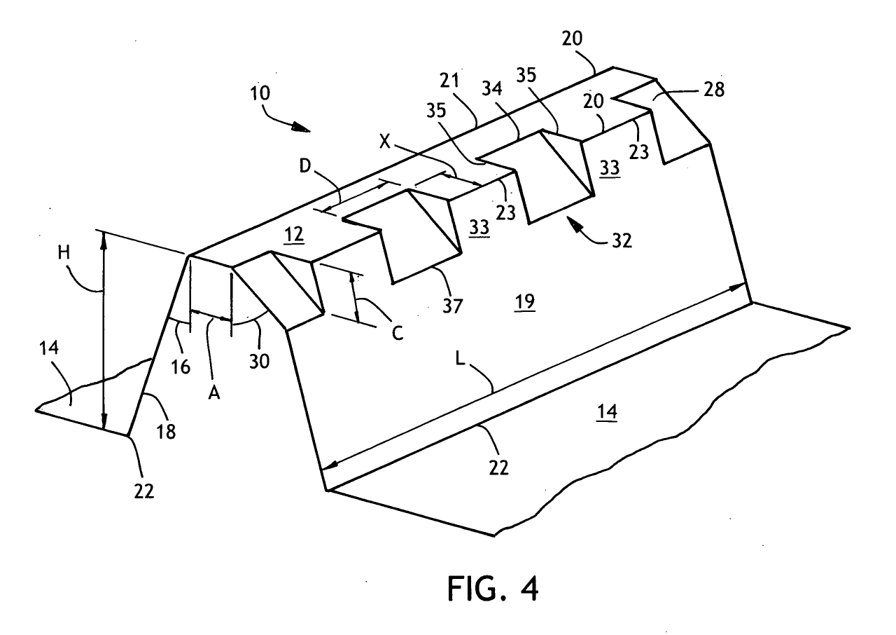

The plurality of notches 32 can include the landing 26 that is substantially parallel with the base 14 and the riser 28 when the notches are shaped as shown in FIGS. 2, 3 and 8. The riser 28 can be angled from an orthogonal axis to the base 14 and the riser angle 30 from an orthogonal axis to the base is generally in the same range as the sidewall angle 16 for the first and second sidewalls (18, 19). In various embodiments of the invention, the riser angle 30 can be between about +3 to about +30 degrees from an orthogonal axis to the base. In other embodiments of the invention for different notches, the landing 26 can be minimized or eliminated, and the sloping riser 28 can form the plurality of notches 32 by forming a narrow chamfer in the first or second edge (21, 23) where the top 12 meets the sidewall 18 as shown in FIG. 4. In such a case, the riser angle 30 is significantly increased relative to the sidewall angle 16. Instead of square notches as shown in FIG. 4, circular, triangular, hemispherical, or other shaped notches could be formed.

The embossing line element's top 12 has a minimum width from the recessed top edge 34 of each notch in the top surface to the opposing first or second edge (21, 23) where the first or second sidewall (18, 19) meets the top 12 designated as A. The plurality of notches 32 each has a maximum width designated as X at the top of the notch 32 measured between the recessed top edge 34 and the corresponding first or second sidewall (18, 19). The riser 28 has a height measured vertically along an orthogonal axis to the base 14 designated as C measured between the top 12 and the bottom of the notch where it meets the sidewall (18, 19) forming a lower outside edge 37. The line embossing element 10 has a length, L, measured along the element where the second sidewall 19 joins the base 14. The length of the embossing line element 10 is the total length measured along the curvature, if any, of the element. In general, the length, L, is greater than or equal to about 0.100″ (about 2.54 mm), or greater than or equal to 3A. As such, the embossing line element 10 is significantly longer than a typical “dot” embossing element having a substantially circular top 12. Finally, each notch 32 has a length, D, where material has been removed from the first or second edge (21, 23) which is significantly less than the length, L, of the embossing line element 10 The inventors have determined that improved embossing clarity in tissue paper results if the geometry of the notches 32 is within specified dimensions, and if certain ratios of the dimensions are within specified ranges. By keeping the parameters within the bounds described in Table 2, the elastomeric surface of the rubber roll is able to flow into the cavity defined by each notch 32 thereby creating additional pinch points along the inside surfaces of the notch. These additional pinch points create more embossing definition in the embossed product when using a steel/rubber embossing nip. Referring to Table 2, the ranges for the parameters in inches and millimeters are provided.

TABLE 2
NOTCH GEOMETRY

| | | Low | | High | |
|---|---|---|---|---|---|
| Parameter | Minimum | Preferred | Desirable | Preferred | Maximum |
| A | 0.010″ | 0.013″ | 0.015″ | 0.045″ | 0.100″ |
| | (0.25 mm) | (0.33 mm) | (0.38 mm) | (1.14 mm) | (2.54 mm) |
| X | 0.010″ | 0.013″ | 0.015″ | 0.045″ | 0.100″ |
| | (0.25 mm) | (0.33 mm) | (0.38 mm) | (1.14 mm) | (2.54 mm) |
| C | 0.0025″ | 0.004″ | 0.005″ | 0.010″ | 0.015″ |
| | (0.06 mm) | (0.10 mm) | (0.13 mm) | (0.25 mm) | (0.34 mm) |
| D | 0.005″ | 0.008″ | 0.010″ | 0.015″ | <L |
| | (0.13 mm) | (0.20 mm) | (0.25 mm) | (0.38 mm) | |
| Ratio C/X | 0.25 | 0.38 | 0.50 | 1.0 | 1.5 |
| Ratio A/X | 0.1 | 0.6 | 1.0 | 3.0 | 10.0 |
| Ratio | 3.0 | >5.5 | >8.0 | 400 | No |
| L/(A + X) | | | | | maximum |

The values of the various parameters in Table 2 are approximate and should be read or construed as if the term approximately or about was placed in front of the number. The individual values listed under the column headings for a single row can be used to form ranges for the particular parameter. A range can be established by taking the minimum value and the maximum value for a parameter. For example, parameter A can be between about 0.010 inch to about 0.1 inch (about 0.25 mm to about 2.54 mm).

Additional ranges within the maximum and minimum for any row can be formed by using any pair of column headings to create two endpoints of the range within the row. For example, possible ranges for any parameter listed are: between the minimum to the maximum, between the minimum to the high preferred, between the minimum to the desirable, between the minimum to the low preferred, between the low preferred to the maximum, between the low preferred to the high preferred, between the low preferred to the desirable, between the desirable to the maximum, between the desirable to the high preferred, or between the high preferred to the maximum.

In general, as the notches become less frequent, the embossing clarity drops off. Furthermore, unless the notches are sufficiently long, D>about 0.015 inch (0.38 mm), it is unlikely that the elastomeric surface of the covered roll will flow in far enough to contact the lower outside edge 37 of each notch. This can reduce the total length of edges available for setting the pattern into the substrate. However, if the notch length (D) becomes too long, the notches may become too prominent in the final embossing pattern. In general, the notches are desirably not noticeable to the unaided eye, which tends to only see the outer shape of the element devoid of the notches. By maintaining the geometry with the ranges specified in Table 2, significantly improved embossing clarity results when using a steel/rubber embossing nip. In general, as the parameters approach the column labeled Desirable improved embossing clarity results in tissue paper products.

In a preferred embodiment for bath tissue and paper napkins, the parameters in Table 2 can be further reduced in range. For bath tissue and napkins, the tissue paper tends to be lower in basis weight and thinner. Also, embossing for bath tissue and paper napkins is more for decorative affect and less for building bulk/volume into the finished product. Thus, for bath tissue and napkins, A can be between about 0.010 inch to about 0.020 inch (about 0.25 mm to about 0.51 mm), X can be between about 0.010 inch to about 0.020 inch (about 0.25 mm to about 0.51), C can be between about 0.010 inch to about 0.020 inch (about 0.25 mm to about 0.51 mm), D can be between about 0.008 inch to about 0.015 inch (about 0.20 mm to about 0.38 mm), the ratio C/X can be between about 0.38 to about 2.0, and the ratio A/X can be between about 0.6 to about 3.0. It is not necessary that all of the parameters are each within the desired ranges.

In a preferred embodiment for paper towels, the parameters in Table 2 can be further reduced in range. For paper towels, the tissue paper tends to be higher in basis weight and thicker. Also, embossing for paper towels is more often performed to generate bulk/volume with less emphasis on decoration. Thus, for paper towels, A can be between about 0.020 inch to about 0.040 inch (about 0.51 mm to about 1.02 mm), X can be between about 0.020 inch to about 0.040 inch (about 0.51 mm to about 1.02 mm), C can be between about 0.004 inch to about 0.010 inch (about 0.10 mm to about 0.25 mm), D can be between about 0.008 inch to about 0.015 inch (0.20 mm to about 0.38 mm), the ratio C/X can be between about 0.38 to about 1.0, and the ratio A/X can be between about 0.6 to about 3.0. It is not necessary that all of the parameters are within each of the identified ranges.

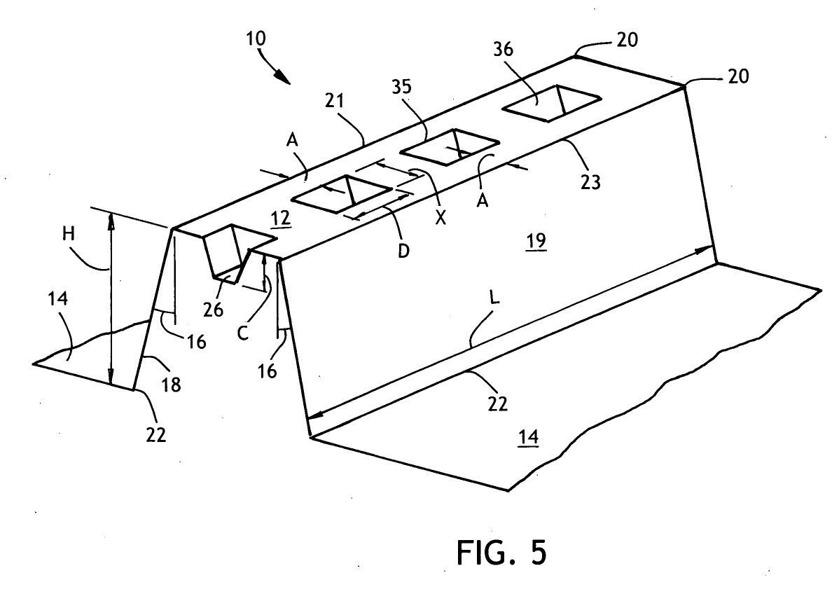

Referring to FIG. 5, another embossing line element 10 is illustrated. The embossing line element 10 can be linear, curvilinear, or a combination of linear and curvilinear segments. The embossing line element 10 has an engraved height, H, that refers to the vertical distance along an orthogonal axis to a base 14. The height is measured between the base 14 and a top 12 and of the embossing line element 10. The chosen element height is often different depending on the embossing pattern and application. Higher element heights are generally used in situations that require a large increase in bulk of the substrate being embossed. Lower element heights are generally used in situations that require a denser finished product. Typical element heights for embossing paper towel substrates are generally between about 0.040 inch to about 0.075 inch (about 1.0 mm to about 1.9 mm), with about 0.055 inch (about 1.4 mm) being fairly common. Typical element heights for bath tissue substrates are generally between about 0.020 inch to about 0.055 inch (about 0.5 mm to about 1.4 mm), with about 0.040 inch (about 1.0 mm) often selected as a starting point. Typical element heights for paper napkin substrates are generally between about 0.025 inch to about 0.045 inch (about 0.6 mm to about 1.1 mm), with about 0.035 inch (about 0.9 mm) being fairly common.

Sidewall angle 16 refers to the angle of a first sidewall 18 and a second sidewall 19 extending from the base 14 of the embossing line element 10 with respect to an orthogonal axis that intersects with the base. Sidewall angles are generally +3 to +30 degrees, with +22 degrees being common. In general, larger sidewall angles are easier to engrave and keep clean of dust in operation, while smaller sidewall angles can provide improved embossing clarity or ply attachment.

A top radius 20 and a bottom radius 22 refer to the radius of curvature at the top and bottom of the embossing element. Bottom radius 22 is the radius along the edges where the first and second sidewalls (18, 19) meet the base 14. Top radius 20 is the radius along the edges of the top 12, such as the first edge 21 where the fist sidewall 18 meets the top 12 or the second edge 23 opposed to the first edge. The top and bottom radii (20, 22) are generally the same, and range from about 0.001 inch to about 0.010 inch (about 0.03 mm to about 0.25 mm), with about 0.005 inch (about 0.13 mm) being fairly common. In general, larger radii are easier to engrave and result in less degradation at a given embossing level, while smaller top radii are better for embossing clarity and result in more bulk at a given embossing level.

Embossing line element 10 also includes a plurality of indentions 36 located in the top 12 of the element. Desirably, the indentions are rectangular or square when viewed from the top; however, they can be triangular, circular, oval or other shape. The embossing line element's top 12 has a minimum width from an inside top edge 35 that circumscribes each indention 36 in the top surface to the opposing first or second edge (21, 23) where the first or second sidewall (18, 19) meets the top 12 designated as A. The indention 36 has a maximum length designated as D and a maximum width designated as X along the line element's respective length and width directions. The indention has a depth measured vertically along an orthogonal axis to the base 14 from the top 12 to the landing 26 or bottom designated as C. The line embossing element 10 has a length, L, measured along the element where the second sidewall 19 joins the base 14. The length of the embossing line element 10 is the total length measured along the curvature, if any, of the element.

The inventors have determined that improved embossing clarity in tissue paper results if the geometry of the indentions 36 is within specified dimensions. By keeping the parameters within the bounds described in Table 3, the elastomeric surface of the rubber roll is able to flow into the cavity defined by the indentions 36 thereby creating additional pinch points when embossing a substrate along the inside top edge 35 circumscribing each indention. These additional pinch points form additional folds or creases in the substrate creating more embossing definition in the embossed product when using a steel/rubber embossing nip. In general as the ranges approach the column labeled Desirable, improved embossing clarity results in tissue paper products. Referring to Table 3, ranges for the parameters are provided in inches and millimeters.

TABLE 3
INDENTION GEOMETRY

| | | Low | | High | |
|---|---|---|---|---|---|
| Parameter | Minimum | Preferred | Desirable | Preferred | Maximum |
| A | 0.010″ | 0.013″ | 0.015″ | 0.045″ | 0.100″ |
| | (0.25 mm) | (0.33 mm) | (0.38 mm) | (1.14 mm) | (2.54 mm) |
| X | 0.010″ | 0.013″ | 0.015″ | 0.045″ | 0.100″ |
| | (0.25 mm) | (0.33 mm) | (0.38 mm) | (1.14 mm) | (2.54 mm) |
| C | 0.0025″ | 0.005″ | 0.010″ | 0.020″ | (X − |
| | (0.06 mm) | (0.13 mm) | (0.25 mm) | (0.51 mm) | 0.005″)/ |
| | | | | | (2 * tan(3 |
| | | | | | degrees)) |
| D | 0.005″ | 0.008″ | 0.010″ | 0.015 | L − 2A |
| | (0.13 mm) | (0.20 mm) | (0.25 mm) | (1.27 mm) | |
| Ratio C/X | 0.25 | 0.38 | 1.0 | 4.0 | 7.0 |
| Ratio A/X | 0.1 | 0.6 | 1.0 | 3.0 | 10.0 |
| Ratio | 3.0 | >5.5 | >8.0 | 400 | No |
| L/(2A + X) | | | | | maximum |

The values of the various parameters in Table 3 are approximate and should be read or construed as if the term approximately or about was placed in front of the number. The individual values listed under the column headings for a single row can be used to form ranges for the particular parameter. A range can be established by taking the minimum value and the maximum value for a parameter. For example, the parameter A can be between about 0.010 inch to about 0.1 inch (about 0.25 mm to about 2.54 mm).

Additional ranges within the maximum and minimum for any row can be formed by using any pair of column headings to create two endpoints of the range within the row. For example, possible ranges for any parameter listed are: between the minimum to the maximum, between the minimum to the high preferred, between the minimum to the desirable, between the minimum to the low preferred, between the low preferred to the maximum, between the low preferred to the high preferred, between the low preferred to the desirable, between the desirable to the maximum, between the desirable to the high preferred, or between the high preferred to the maximum.

In a preferred embodiment for bath tissue and paper napkins, the parameters in Table 3 can be further reduced in range. For bath tissue and napkins, the tissue paper tends to be lower in basis weight and thinner. Also, embossing for bath tissue and paper napkins is more for decorative affect and less for building bulk/volume into the finished product. Thus, for bath tissue and napkins, A can be between about 0.010 inch to about 0.020 inch (about 0.25 mm to about 0.51 mm), X can be between about 0.010 inch to about 0.020 inch (about 0.25 mm to about 0.51 mm), C can be between about 0.010 inch to about 0.020 inch (about 0.25 mm to about 0.51 mm), D can be between about 0.008 inch to about 0.015 inch (about 0.29 mm to about 0.38 mm), the ratio C/X can be between about 0.38 to about 2.0, and the ratio A/X can be between about 0.6 to about 3.0. It is not necessary that all of the parameters are each within the desired ranges.

In a preferred embodiment for paper towels, the parameters in Table 3 can be further reduced in range. For paper towels, the tissue paper tends to be higher in basis weight and thicker. Also, embossing for paper towels is more often performed to generate bulk/volume with less emphasis on decoration. Thus, for paper towels, A can be between about 0.015 inch to about 0.030 inch (about 1.27 mm to about 0.76 mm), X can be between about 0.010 inch to about 0.020 inch (about 0.25 mm to about 0.51 mm), C can be between about 0.004 inch to about 0.010 inch (about 0.10 mm to 0.25 mm), D can be between about 0.008 inch to about 0.015 inch (0.20 mm to about 1.27 mm), the ratio C/X can be between about 0.38 to about 1.0, and the ratio A/X can be between about 0.6 to about 3.0. It is not necessary that all of the parameters are within each of the identified ranges.

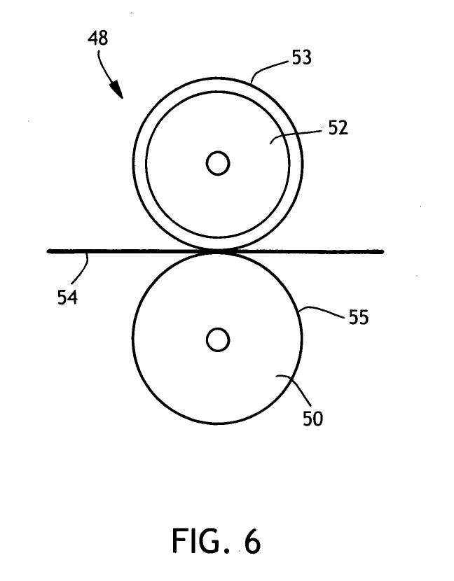

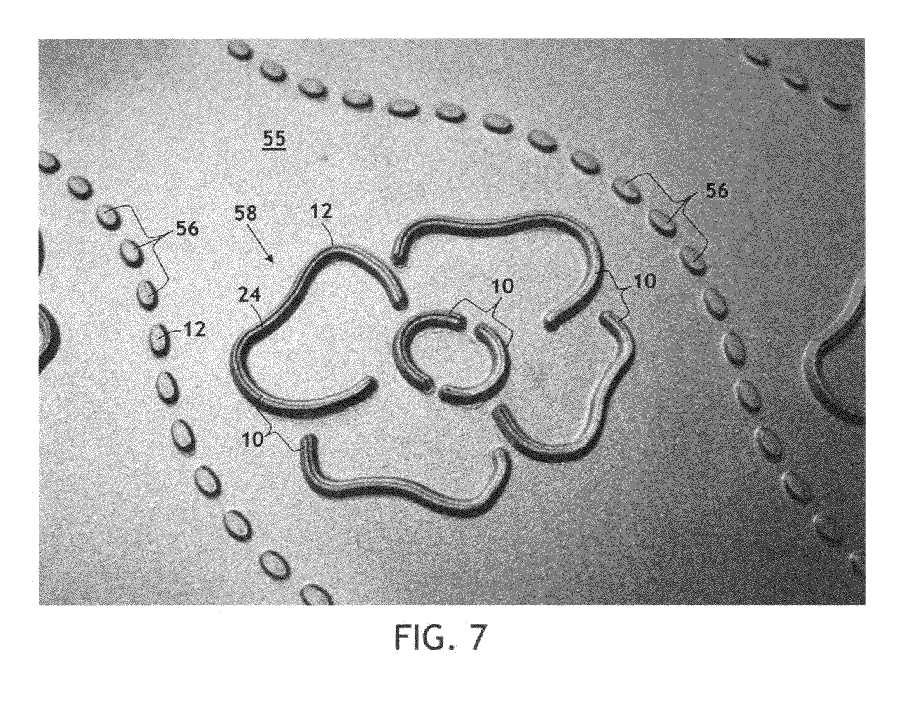

Referring now to FIG. 6 an embossing apparatus 48 including a rigid embossing roll 50 nipped with an elastomeric roll 52 having an outer elastomeric surface 53 is shown. A paper web 54 is disposed in the nip between the embossing roll 50 and elastomeric roll 52. The embossing surface 55 of the embossing roll contains a raised engraving pattern. Referring to FIG. 7, a close up of one embodiment of the embossing surface 55 is shown. The embossing surface 55 contains a plurality of dot embossing elements 56 disposed in a curved line pattern and a plurality of flower embossing elements 58 disposed between the line patterns. The dot embossing elements 56 have a flat top 12 (no steps, notches, or indentions) and are conventionally formed. The flower embossing elements 58 are formed from curvilinear line elements 10 having a step 24 along the inside edge of the element's top 12 as depicted in FIG. 1. Testing of the curvilinear line elements 10 forming the flower embossing elements 58 showed significantly improved embossing definition or clarity in tissue paper when compared to tissue paper embossed with flower embossing elements having the same pattern, but formed with a flat top (no steps, notches, or indentions) like the dot embossing elements 56.

Modifications and variations to the present invention may be practiced by those of ordinary skill in the art, without departing from the spirit and scope of the present invention, which are more particularly set forth in the appended claims. For example, the same principles disclosed above for the design of a male embossing element can be applied to the design of a female embossing element. It is understood that aspects of the various embodiments may be interchanged in whole or part. All cited references, patents, or patent applications in the above application for letters patent are herein incorporated by reference in a consistent manner. In the event of inconsistencies or contradictions between the incorporated references and this specification, the information present in this specification shall prevail. The preceding description, given by way of example in order to enable one of ordinary skill in the art to practice the claimed invention, is not to be construed as limiting the scope of the invention, which is defined by the claims and all equivalents thereto.

We claim:

1. An apparatus comprising:
a rigid embossing roll having an embossing surface containing at least one embossing line element;
an elastomeric covered roll opposing the rigid embossing roll;
the at least one embossing line element comprising a top having a first edge, a second edge opposing the first edge, and a width, A, measured between the first and the second edge; a step located adjacent to either the first or the second edge, the step having a riser and a landing; the landing having a width, B, measured between the riser and a sidewall of the embossing line element; the riser having a vertical height, C, measured along an axis orthogonal to a base of the embossing line element between the landing and the top; and
wherein A is between about 0.010 inch to about 0.100 inch, B is between about 0.010 inch to about 0.100 inch, C is between about 0.0025 inch to about 0.015 inch; a ratio of C/B is between about 0.25 to about 1.5; and a ratio of A/B is between about 0.1 to about 10.0.

2. The apparatus of claim 1 wherein the at least one embossing line element comprises a length, L, measured along the element where the sidewall meets the base and a ratio of L/(A+B) is greater than about 3.0.

3. The apparatus of claim 1 wherein A is between about 0.010 inch to about 0.020 inch.

4. The apparatus of claim 1 wherein B is between about 0.010 inch to about 0.020 inch.

5. The apparatus of claim 1 wherein C is between about 0.004 inch to about 0.010 inch.

6. The apparatus of claim 1 wherein A is between about 0.010 inch to about 0.020 inch, B is between about 0.010 inch to about 0.020 inch; and C is between about 0.004 inch to about 0.010 inch.

7. The apparatus of claim 1 wherein A is between about 0.020 inch to about 0.040 inch.

8. The apparatus of claim 1 wherein B is between about 0.020 inch to about 0.040 inch.

9. The apparatus of claim 1 wherein A is between about 0.020 inch to about 0.040 inch, B is between about 0.020 inch to about 0.040 inch; and C is between about 0.004 inch to about 0.010 inch.

10. The apparatus of claim 1 comprising a plurality of integral blocks located along the step forming a plurality of notches along the first or the second edge of the top.

11. The apparatus of claim 10 wherein the notches are substantially square in shape.

12. The apparatus of claim 1 comprising a step located adjacent both the first and the second edges of the top, a plurality of integral blocks located along both steps forming a plurality of notches along both the first and the second edges, and wherein the plurality of notches are staggered and offset from the first edge to the second edge, and a notch does not extend all the way from the first edge to the second edge.

13. An apparatus comprising:
a rigid embossing roll having an embossing surface containing at least one embossing line element;
an elastomeric covered roll opposing the rigid embossing roll;
the at least one embossing line element comprising a top having a first edge, a second edge opposing the first edge, and a plurality of notches located along either the first or the second edge; each notch having a recessed top edge inboard of the first or the second edge; the top having a width, A, measured between the first or the second edge and the recessed top edge of the notch; each notch having a width, X, measured between the recessed top edge and the first or second edge; each notch having a height, C, measured vertically along an orthogonal axis to a base of the embossing line element between the top and a lower outside edge where the notch meets a first or a second sidewall of the embossing line element; the at least one embossing line element comprises a length, L, measured along the element where the first or the second sidewall meets the base; each notch having a length D measured parallel to either the first or the second edge; and
wherein A is between about 0.010 inch to about 0.100 inch, X is between about 0.010 inch to about 0.100 inch, C is between about 0.0025 inch to about 0.015 inch; D is between about 0.005 inch to 0.015 inch, a ratio of C/X is between about 0.25 to about 1.5; and a ratio of A/X is between about 0.1 to about 10.0.

14. The apparatus of claim 13 wherein a plurality of notches are located along both the first and the second edges, and a notch does not extend all the way from the first edge to the second edge.

15. The apparatus of claim 14 wherein the plurality of notches are staggered and offset from the first edge to the second edge.

16. The apparatus of claim 13 wherein A is between about 0.010 inch to about 0.020 inch, X is between about 0.010 inch to about 0.020 inch, C is between about 0.010 inch to about 0.020 inch, and D is between about 0.008 inch to about 0.015 inch.

17. The apparatus of claim 13 wherein A is between about 0.020 inch to about 0.040 inch, X is between about 0.020 inch to about 0.040 inch, C is between about 0.004 inch to about 0.010 inch, and D is between about 0.008 inch to about 0.015 inch.

18. An apparatus comprising:
a rigid embossing roll having an embossing surface containing at least one embossing line element;
an elastomeric covered roll opposing the rigid embossing roll;
the at least one embossing line element comprising a top having a first edge, a second edge opposing the first edge, and a plurality of indentations located in the top; each indention having an inside top edge that circumscribes each indention; the top having a width, A, measured between the first or the second edge and the inside top edge; each indention having a length, D, measured parallel to the first or the second edge; each indentation having a width, X, measured orthogonally to the length; each indention having a depth, C, measured vertically along an orthogonal axis to a base of the embossing line element between the top and a landing; the at least one embossing line element comprises a length, L, measured along the element where the first or the second sidewall meets the base; and
wherein A is between about 0.010 inch to about 0.100 inch, X is between about 0.010 inch to about 0.100 inch, C is between about 0.0025 inch to about (X-0.005 inch)/(2*tan(3 degrees)); D is between about 0.005 inch to about L-2A; a ratio of C/X is between about 0.25 to about 7.0; and a ratio of A/X is between about 0.1 to about 10.0.

19. The apparatus of claim 18 wherein a ratio of L/(2A+X) is greater than about 3.0.

20. The apparatus of claim 18 wherein the indentions are substantially square in shape.

21. The apparatus of claim 18 wherein A is between about 0.010 inch to about 0.020 inch, X is between about 0.010 inch to about 0.020 inch, C is between about 0.010 inch to about 0.020 inch, and D is between about 0.008 inch to about 0.015 inch.

22. The apparatus of claim 18 wherein A is between about 0.015 inch to about 0.030 inch, X is between about 0.010 inch to about 0.020 inch, C is between about 0.004 inch to about 0.010 inch, and D is between about 0.008 inch to about 0.015 inch.
